(19) United States
(12) Patent Application Publication
(10) Pub. No.: US 2003/0098015 A1
(43) Pub. Date: May 29, 2003

(54) Fuel injection apparatus for an internal combustion engine

(75) Inventor: Roger Potschin, Brackenheim (DE)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 10/287,499

(22) Filed: Nov. 5, 2002

(30) Foreign Application Priority Data
Nov. 10, 2001 (DE) 1 01 55 412.5

(51) Int. Cl. F02M 37/04

(52) U.S. Cl. 123/446; 123/506

(57) ABSTRACT

The fuel injection apparatus has a high-pressure fuel pump and a fuel injection valve connected to it for each cylinder of the internal combustion engine. A pump piston of the high-pressure fuel pump is set into a stroke motion by the engine and defines a pump working chamber that is connected to a pressure chamber of the fuel injection valve, which has an injection valve member that controls at least one injection opening and can be moved in an opening direction by the pressure prevailing in the pressure chamber, counter to a closing force. A first control valve device controls an unthrottled connection and a connection by means of a throttle restriction between the pump working chamber and a relief chamber, and a second control valve device controls a connection between a control pressure chamber of the fuel injection valve, which is connected to the pump working chamber, and a relief chamber, wherein the pressure prevailing in the control pressure chamber acts on the injection valve member in the closing direction.

### BACKGROUND OF THE INVENTION

1. Field of the Invention

The invention is directed to an improved fuel injection apparatus for an internal combustion engine.

2. Description of the Prior Art

A fuel injection apparatus of the type with which this invention is concerned is known from EP 0 957 261 A1. This fuel injection apparatus has a high-pressure fuel pump and a fuel injection valve connected to it for each cylinder of the internal combustion engine. The high-pressure fuel pump has a pump piston, which the engine sets into a stroke motion and which defines a pump working chamber. The fuel injection valve has a pressure chamber connected to the pump working chamber and an injection valve member, which controls at least one injection opening and which the pressure prevailing in the pressure chamber can move in the opening direction, counter to a closing force, in order to open the at least one injection opening. A first control valve device is provided, which is comprised of a control valve and controls a connection between the pump working chamber and a relief chamber. A second control valve device is also provided, which is comprised of a control valve and controls a connection between a control pressure chamber and a relief chamber. The pressure prevailing in the control pressure chamber acts on the injection valve member at least indirectly in the closing direction and the control pressure chamber is connected to the pump working chamber. The two control valve devices are switched by means of a single shared electromagnetic actuator. In this known fuel injection apparatus, it is disadvantageous that a fuel injection is only possible in accordance with the pressure level generated by the fuel pump and the pressure at which the fuel injection occurs cannot be changed.

### OBJECT AND SUMMARY OF THE INVENTION

The fuel injection apparatus according to the invention has the advantage over the prior art that the first control valve device, when it opens the throttled connection between the pump working chamber and the relief chamber or when the connection between the pump working chamber and the relief chamber is opened by means of the throttle restriction or the pressure control valve, permits a fuel injection at a reduced pressure level. As a result of this, a preinjection of fuel can occur at a reduced pressure level and/or the beginning of a main injection can occur at a reduced pressure level, which permits a reduction of the pollutant emissions and noise of the internal combustion engine.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 schematically depicts a fuel injection apparatus for an internal combustion engine according to a first exemplary embodiment,

FIG. 2 shows an enlarged detail labeled 11 of the fuel injection apparatus, with a modified embodiment,

FIG. 3 shows a march of pressure at injection openings of a fuel injection valve of the fuel injection apparatus,

FIG. 4 schematically depicts the fuel injection apparatus according to a second exemplary embodiment,

FIG. 5 shows a structural embodiment of the fuel injection apparatus according to the second exemplary embodiment, and

FIG. 6 shows an enlarged detail labeled VI of the fuel injection apparatus from FIG. 5.

### DESCRIPTION OF THE PREFERRED EMBODIMENTS

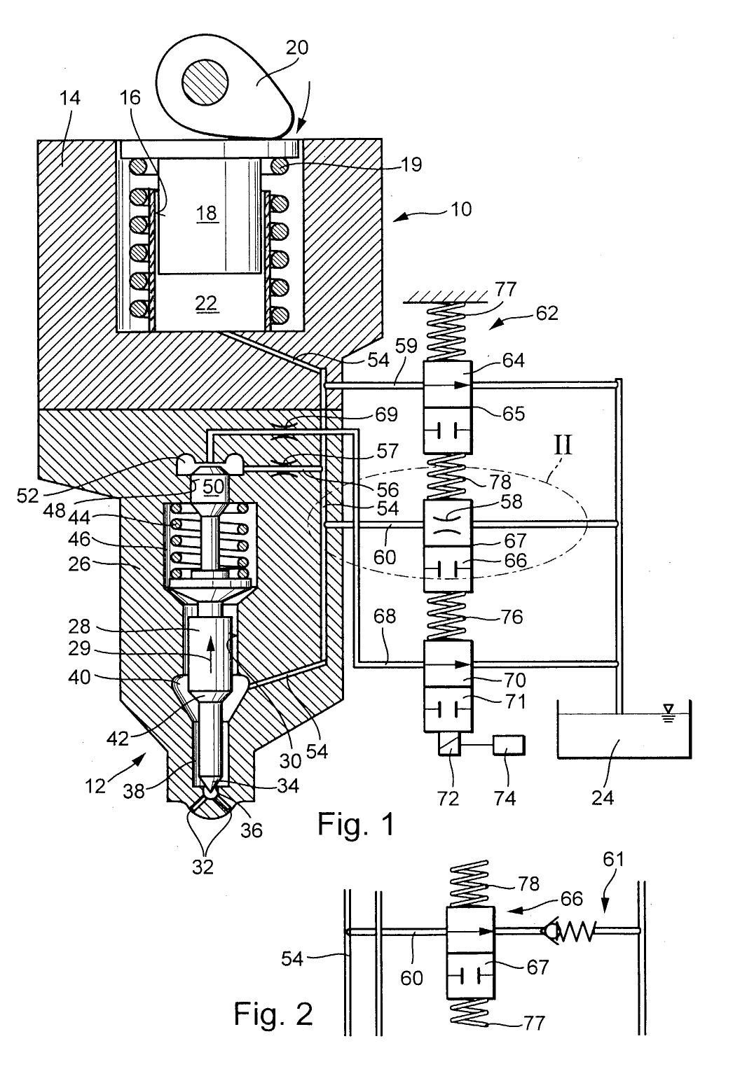

FIGS. 1, 2 and 4 to 6 show a fuel injection apparatus for an internal combustion engine of a motor vehicle. The engine is preferably a compression-ignition engine. The fuel injection apparatus is preferably embodied as a so-called unit injector and for each cylinder of the engine, has a high-pressure fuel pump 10 and a fuel injection valve 12 connected to it, which form a combined component. Alternatively, the fuel injection apparatus can also be embodied as a so-called unit pump system in which the high-pressure fuel pump and the fuel injection valve of each cylinder are disposed separately from each other and are connected to each other by means of a line. The high-pressure fuel pump 10 has a pump body 14 with a cylinder bore 16, in which a pump piston 18 is guided in a sealed fashion, which is driven at least indirectly by a cam 20 of a camshaft of the engine to execute a stroke motion counter to the force of a restoring spring 19. In the cylinder bore 16, the pump piston 18 defines a pump working chamber 22 in which fuel is compressed under high pressure during the delivery stroke of the pump piston 18. The pump working chamber 22 is supplied with fuel from a fuel tank 24 of the motor vehicle.

The fuel injection valve 12 has a valve body 26, which is connected to the pump body 14 and can be comprised of several parts, and in which an injection valve member 28 is guided so that it can move longitudinally in a bore 30. In its end region oriented toward the combustion chamber of the engine cylinder, the valve body 26 has at least one, preferably several, injection openings 32. In its end region oriented toward the combustion chamber, the injection valve member 28 has a for example approximately conical sealing surface 34 that cooperates with a valve seat 36, which is embodied in the valve body 26 in its end region oriented toward the combustion chamber, and the injection openings 32 lead away from this seat or branch off downstream of it. In the valve body 26, between the injection valve member 28 and the bore 30 toward the valve seat 36, there is an annular chamber 38, which in its end region oriented away from the valve seat 36, transitions by means of a radial expansion of the bore 30 into a pressure chamber 40 that encompasses the injection valve member 28. At the level of the pressure chamber 40, the injection valve member 28 has a pressure shoulder 42 produced by a cross sectional reduction. A prestressed closing spring 44 acts on the end of the injection valve member 28 oriented away from the combustion chamber and presses the injection valve member 28 toward the valve seat 36. The closing spring 44 is disposed in a spring chamber 46 of the valve body 26, which chamber adjoins the bore 30. At its end oriented away from the bore 30 in the valve body 26, the spring chamber 46 is adjoined by another bore 48, which has a control piston 50 guided in it in a sealed fashion, which is connected to the injection valve member 28. With its end face oriented away from the injection valve member 28, the piston 50 defines a control pressure chamber 52 in the valve body 26. The valve body 26 and the pump body 14 contain a conduit 54, which connects the pressure chamber 40 to the pump working chamber 22.

FIG. 1 shows the fuel injection apparatus according to a first exemplary embodiment. A conduit 56 branches from the conduit 54 to the control pressure chamber 52; preferably, at least one throttle restriction 57 is provided in the conduit 56. A first connection 59 branches from the conduit 54 to a relief chamber, which function can be at least indirectly fulfilled by the fuel tank 24, for example, or by another low-pressure region. A second connection 60 also branches from the conduit 54 to a relief chamber 24. In the first exemplary embodiment, the fuel injection apparatus has a first control valve device 62, which is comprised of two control valves 64 and 66. A first control valve 64 controls the first connection 59 of the conduit 54 and therefore of the pump working chamber 22 to the relief chamber 24 and a second control valve 66 controls the second connection of the conduit 54 and therefore the pump working chamber 22 to the relief chamber 24. The two control valves 64, 66 are each embodied as 2/2-port directional-control valves and can be switched between a first switched position in which the connection 59 or 60 is open and a second switched position in which the connection 59 or 60 is closed. In the first open switched position, the first control valve 64 opens an unthrottled connection by means of the connection 59. In the first open switched position, the second control valve 66 opens a throttled connection to a throttle restriction 58 by means of the connection 60.

A connection 68 branches from the control pressure chamber 52 to a relief chamber, which function can once again be at least indirectly fulfilled by the fuel tank 24. For example, a throttle location 69 is provided in the connection 68. The connection 68 is controlled by a second control valve device 70, which is comprised of a control valve that is embodied as a 2/2-port directional-control valve and can be switched between a first switched position in which the connection 68 is open and a second switched position in which the connection 68 is closed.

The two control valve devices 62 and 70 are actuated by a single, shared electromagnetic actuator 72. An electronic control device 74 activates the actuator 72. The control valves 64, 66, and 70 each have a valve member 65, 67, and 71; for example, the actuator 72 engages the valve member 71 of the control valve 70. The valve member 67 of the control valve 66 is coupled to the valve member 71 of the control valve 70 by means of a first spring 76. The valve member 65 of the control valve 64 is coupled to the valve member 67 of the control valve 66 by means of a second spring 78. The valve member 65 of the control valve 64 is also engaged by a third spring 77 that acts in opposition to the spring 78. The springs 76, 77, and 78 are matched to one another in such a way that when the actuator 72 is supplied with different levels of current, the control valves 64, 66, and 70 can be switched between their first and second switched positions, partially independently of one another. When the actuator 72 is not supplied with current, then all of the control valves 64, 66, and 70 are disposed in their respective first switched positions so that the connections 59, 60, and 68 are open. It is then possible, when the actuator 72 is supplied with a low, first level of current, to initially bring the first control valve 64 into its second switched position so that the connection 59 is closed. The control valves 66 and 70 then remain in their first switched positions so that the connections 60 and 68 are open. The conduit 54 and therefore the pump working chamber 22 consequently have a throttled connection 60 to the relief chamber 24 by means of the open control valve 66 and high pressure cannot buildup in the control pressure chamber 52 since it is connected to the relief chamber 24 by means of the open control valve 70. When the actuator 72 is supplied with a second, higher level of current, the control valve 64 remains in its closed switched position and in addition, the control valve 66 is also brought into its second closed switched position, while control valve 70 continues to remain in its first open switched position. Consequently, the conduit 54 and the pump working chamber 22 are disconnected from the relief chamber 24 and high pressure builds up in it in accordance with the stroke motion of the pump piston 18. When the actuator 72 is supplied with a third, even higher level of current, the control valves 64, 66 remain in their closed switched positions and finally, the control valve 70 is also switched into its second closed switched position. Consequently, the control pressure chamber 52 is disconnected from the relief chamber 24 and high pressure builds up in it as it does in the pump working chamber 22.

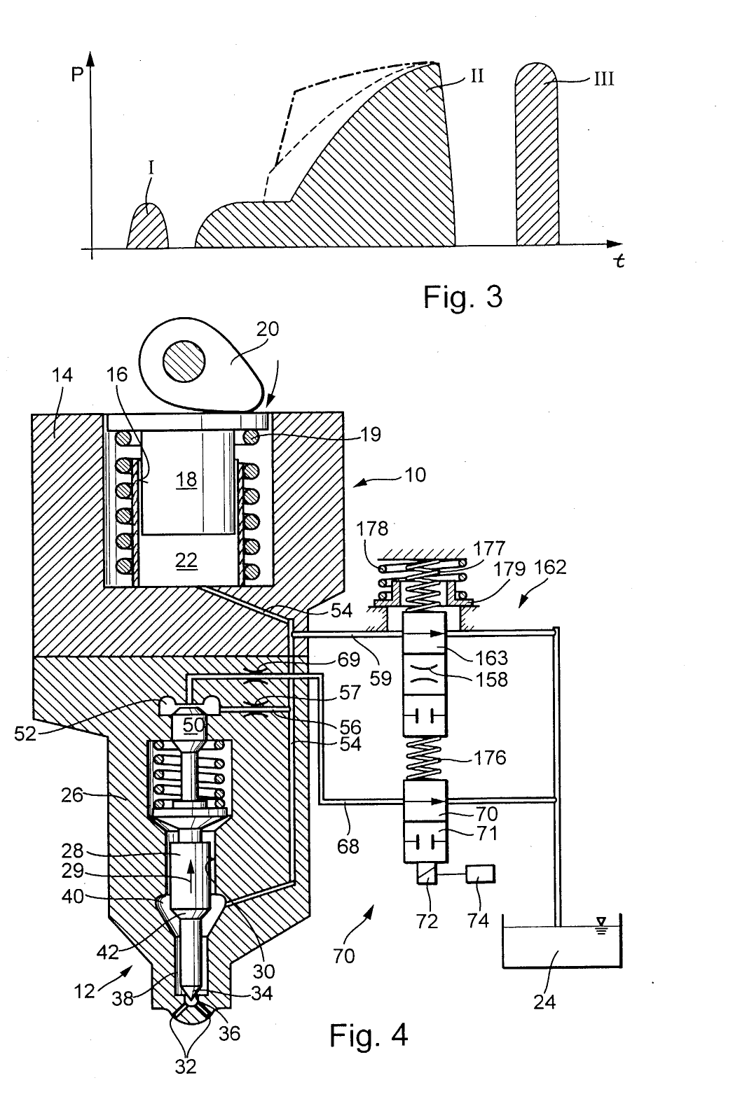

The function of the fuel injection apparatus will be explained below in accordance with the first exemplary embodiment. FIG. 3 depicts the march of pressure p at the injection openings 32 of the fuel injection valve 12 over time t during an injection cycle. During the intake stroke of the pump piston 18, it is supplied with fuel from the fuel tank 24. During the delivery stroke of the pump piston 18, the fuel injection begins with a preinjection, in which the control valve 64 is closed in that the control device 74 activates the actuator 72 with the first level of current. The conduit 54 and the pump working chamber 22 are then only connected to the relief chamber 24 by means of the open, throttled connection 60 so that an increased pressure builds up in it, but one which is less than the full pressure generated by the stroke motion of the pump piston 18. The control pressure chamber 52 is connected to the relief chamber 24 so that high pressure cannot buildup in it. When the pressure prevailing in the pressure chamber 40 of the fuel injection valve 12 has reached such a level that it exerts a force acting in the opening direction 29 on the injection valve member 28 by means of the pressure shoulder 42, which force is greater than the force of the closing spring 44 and the force exerted on the piston 50 by the residual pressure prevailing in the control pressure chamber 52, then the sealing surface 34 of the injection valve member 28 lifts away from the valve seat 36 and fuel is injected through the injection openings 32 into the combustion chamber of the cylinder of the internal combustion engine. Because the second control valve 70 is open, the opening pressure of the fuel injection valve 12 therefore depends only on the force of the closing spring 44 and the force exerted on the piston 50 by the residual pressure prevailing in the control pressure chamber 52. The preinjection corresponds to an injection phase labeled I in FIG. 3. The preinjection is executed at a reduced pressure due to the open, throttled connection 60 of the pump working chamber 22.

In order to terminate the preinjection, the control valve 64 is opened again, thus opening the unthrottled connection 59 of the pump working chamber 22 to the relief chamber 24, so that increased pressure cannot build up in the pump working chamber 22, and the closing spring 44 closes the fuel injection valve 12. Alternatively, the invention can also provide that in order to terminate the preinjection, the control device 74 supplies the actuator 72 with the high third level of current so that the control valve 70 is closed, as a result of which high pressure builds up in the control pressure chamber 52, which acts on the piston 50 and thereby closes the fuel injection valve 12.

For a subsequent main injection, the control device 74 supplies the actuator 72 with the first level of current so that the control valve 64 is disposed in its closed switched position and the pump working chamber 22 has the open, throttled connection 60 to the relief chamber 24, allowing an increased pressure to build up in it, but one which is less than the high pressure that builds up according to the stroke motion of the pump piston 18 when the relief chamber 24 is completely disconnected. When the pressure in the pressure chamber 40, by means of the pressure shoulder 42, generates a greater force on the injection valve member 28 than the closing spring 44 and the pressure prevailing in the control pressure chamber 52 do, then the fuel injection valve 12 opens for the main injection. The main injection is labeled II in FIG. 3 and begins at a reduced pressure level. At a predetermined time, when the control device 74 supplies the actuator 72 with the increased second level of current, the control valve 66 is brought into its closed second switched position so that the pump working chamber 22 is completely disconnected from the relief chamber 24 and high pressure builds up in it according to the stroke motion of the pump piston 18. The remaining main injection then occurs at high pressure, as shown in FIG. 2. By varying the time in which the control valve 66 is brought into its closed switched position, the time of the pressure increase and the course of the pressure increase during the main injection can be varied and therefore optimally adapted to the operating conditions of the engine. The invention can also include the provision that before the beginning of the main injection, all of the control valves 64, 66, and 70 are brought into their closed positions so that the pump working chamber 22 is disconnected from the relief chamber 24 and the control pressure chamber 52 is disconnected from the relief chamber 24. By varying the time in which the control valve 70 is brought into its open position, the pressure at which the fuel injection valve 12 opens and the fuel injection begins can be varied, as shown with dashed lines in FIG. 3.

In order to terminate the main injection, the control valve 70 is brought into its closed switched position by virtue of the control device 74 supplying the actuator 72 with the third, high level of current. The control pressure chamber 52 is then disconnected from the relief chamber 24 so that high pressure builds up in it, which closes the fuel injection valve 12. In order to produce a secondary injection, the control valve 70 is once again opened by virtue of the actuator 72 being supplied with the second level of current so that the control pressure chamber 52 is once again pressure-relieved and the fuel injection valve 12 opens. The secondary injection corresponds to an injection phase labeled III in FIG. 3. In order to terminate the secondary injection, the control device 74 switches the actuator 72 into a currentless state so that all of the control valves 64, 66, and 70 are moved into their open first switched positions and the fuel injection valve 12 closes.

The throttle restriction 58 can be disposed in the control valve 66 as shown in FIG. 1. However, the throttle restriction 58 can alternatively also be disposed in connection 60, upstream or downstream of the control valve 66. Alternatively, in lieu of the throttle restriction 58, a pressure control valve 61 can also be provided, which opens in the direction of the relief chamber 24. When a predetermined pressure in the pump working chamber 22 is exceeded, the pressure control valve 61 opens, thus permitting a preinjection and the beginning of a main injection at a reduced pressure. The pressure control valve 1 can also be embodied as a constant pressure valve.

FIGS. 4 to 6 show the fuel injection apparatus according to a second exemplary embodiment. The basic design with the high-pressure fuel pump 10, the fuel injection valve 12, and the second control valve device 70 is the same as in the first exemplary embodiment, but the design of the first control valve device 162 has been modified and will be explained in detail below. From the conduit 54 and therefore the pump working chamber 22, only one connection 59 leads to the relief chamber 24, and this connection is controlled by the first control valve device 162. The first control valve device 162 is comprised of a single control valve, which is embodied as a 2/3-port directional-control valve. The control valve 162 can be switched between three switched positions; it is completely open in a first switched position, unblocks a passage with a throttle restriction 158 in a second switched position, and is completely closed in a third switched position.

The first control valve 162 and the second control valve 70 are actuated by the single, shared electromagnetic actuator 72, which is activated by the control device 74. The first control valve 162 has a valve member 163, which is coupled to the valve member 71 of the second control valve 70 by means of a spring 176. The valve member 163 of the first control valve 162 is supported by means of a second spring 177, which functions in opposition to the spring 176. A third spring 178 is also provided, which is supported by means of a movable support 179, which the valve member 163 comes into contact with after reaching its second switched position and which is counteracted by the first spring 176.

The function of the fuel injection apparatus will be explained below in conjunction with the second exemplary embodiment. When the actuator 72 is without current, the two control valves 162 and 70 are each disposed in their completely open positions. For the preinjection, the control device 74 supplies the actuator 72 with a first increased level of current so that the first control valve 162 is brought into its second open switched position in which the pump working chamber 22 is connected to the relief chamber 24 by means of the throttle restriction 158. The second control valve 70 remains open. In order to terminate the preinjection, the first control valve 162 is brought into its first open switched position by virtue of the control device 74 switching the actuator 72 into the currentless state so that the pump working chamber 22 is pressure-relieved and the fuel injection valve 12 closes. For the beginning of the main injection, the control device 74 once again supplies the actuator 72 with the first increased level of current so that the first control valve 162 is brought into its second open switched position and the connection 59 by means of the throttle restriction 158 is opened. For the remaining main injection, the control device 74 supplies the actuator 72 with the second, further increased level of current so that the first control valve 162 is brought into its third closed switched position and the pump working chamber 22 is disconnected from the relief chamber 24. The second control valve 70 once again remains open. Alternatively, as described in the first exemplary embodiment, the invention can also include the provision that both of the control valves 162 and 70 are closed before the main injection and for the main injection, the control valve 70 is opened so that the march of pressure in the main injection 11 shown with dashed lines in FIG. 3 is produced. In order to terminate the main injection, the control device 74 supplies the actuator 72 with the third, highest level of current so that the second control valve 70 is also brought into its closed switched position. The control pressure chamber 52 is then disconnected from the relief chamber 24 so that high pressure builds up in it, as it does in the pump working chamber 22, and the fuel injection valve 12 closes. For a subsequent secondary injection, the control device 74 supplies the actuator 72 with the second level of current so that the second control valve 70 is brought into its open switched position and the control pressure chamber 52 is pressure-relieved so that the fuel injection valve 12 opens once again. In order to terminate the fuel injection, the control device 74 switches the actuator 72 into the currentless state so that both of the control valves 162 and 70 are completely open and the fuel injection valve 12 closes.

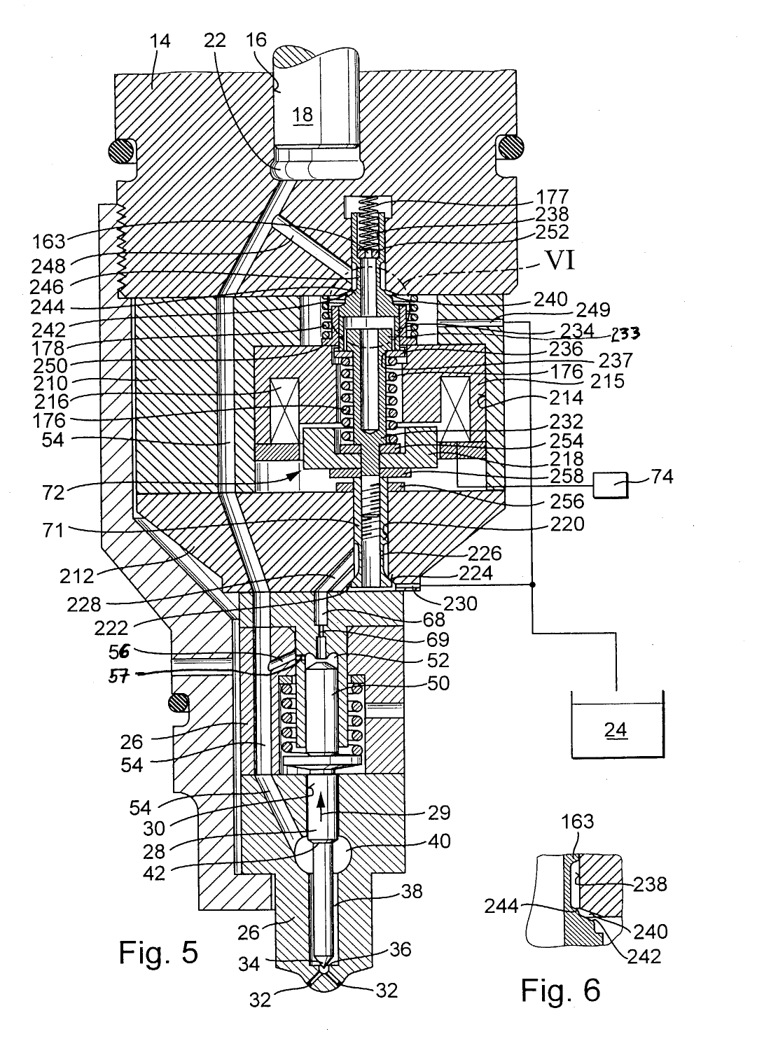

FIG. 5 shows a structural embodiment of the fuel injection apparatus according to the second exemplary embodiment. The structural embodiment of the control valves 162 and 70 from FIG. 5 will now be explained in detail. Two intermediary bodies 210 and 212 are disposed between the pump body 14 and the valve body 26; the conduit 54 from the pump working chamber 22 to the pressure chamber 40 extends through these two intermediary bodies. In addition to the conduit 54, the intermediary body 210 also has a stepped bore 214, which has a smaller diameter toward the pump body 14 than it does toward the intermediary body 212. The larger diameter region of the bore 214 has an electromagnetic actuator 72 inserted into it, which has a stationary magnetic coil 216 disposed in a coil body 215 and has a movable magnet armature 218. The magnet armature 218 is connected to the valve member 71 of the second control valve 70. The valve member 71 protrudes into a bore 220, which is embodied in the intermediary body 212 and which widens out in its end region oriented toward the valve body 26, forming a conical valve seat 222. At its end oriented toward the valve body 26, the valve member 71 has a greater diameter than in its other region disposed in the bore 220; a conical sealing surface 224 is embodied at the end of the valve member 71. A reduced diameter region 226 is provided on the valve member 71, between the sealing surface 224 and the shaft of the valve member 71 guided in the bore 220. A bore 228, which is connected to the control pressure chamber 52, connects to the bore 220 that contains the region 226 of the valve member 71. From the end region of the bore 220 where it has a larger diameter, a bore 230 leads through the intermediary body 212 and to the relief chamber 24. If the sealing surface 224 of the valve member 71 is spaced apart from the valve seat 222, then the control valve 70 is open and the control pressure chamber 52 is connected to the relief chamber 24 by means of the bore 228, the bore 220 along the region 226 of the valve member 71, and through the bore 230. When the sealing surface 224 of the valve member 71 rests against the valve seat 222, then the control valve 70 is closed and the control pressure chamber 52 is disconnected from the relief chamber 24.

The magnet armature 218 is also connected to a rod 232, which passes through a bore in the actuator 72 and its free end 233 is diametrically enlarged and protrudes into a sleeve 234, which is connected to the valve member 163 of the control valve 162. The end of the sleeve 234 oriented toward the valve member 71 of the second control valve 70 is covered by a disk 236 that has an opening 237, which is smaller in diameter than the end 233 of the rod 232 and which the rod 232 passes through. The first spring 176 is clamped between the disk 236 and the magnet armature 218. The first spring 176 acts on the valve member 71 of the second control valve 70 in the direction of its open position. The valve member 163 protrudes with its shaft oriented away from the rod 232 into a bore 238 in the pump body 14. The valve member 163 can be embodied as hollow and the second spring 177 is clamped between it and the bottom of bore 238.

A conical valve seat 240 is embodied at the mouth of the bore 238 into the bore 214 and the valve member 163 has a conical sealing surface 242 embodied on it, which cooperates with the valve seat 240. As depicted in an enlarged fashion in FIG. 6, at its end oriented further into the bore 238, the sealing surface 242 on the valve member 163 is adjoined by a cylindrical section 244, which is in turn adjoined by a reduced diameter section 246. In the vicinity of the section 246 of the valve member 163, a conduit 248 leading away from the conduit 54 feeds into the bore 238. The intermediary body 210 contains a bore 249, which feeds into the bore 214 and is connected to the relief chamber 24. In its section contained in the bore 214, the valve member 163 is encompassed by a sleeve 250, which can move in relation to the valve member 163. The sleeve 250 is L-shaped in the longitudinal section, with the short leg pointing toward the actuator 72. The third spring 178 is clamped between the sleeve 250 and the pump body 14 encompassing the bore 238.

If the magnetic coil 216 is without current, then no attraction is exerted on the magnet armature 218 and the first control valve 162 and the second control valve 70 are disposed in their open position due to the force of the first spring 176 and the second spring 177. The valve member 163 of the first control valve 162 is disposed with its sealing surface 242 spaced apart from the valve seat 240 and its cylindrical section 244 does not protrude into the bore 238. Consequently, the valve member 163 opens up an unthrottled connection of the conduit 248 through the bore 238 along the section 246 of the valve member 163, into the bore 214 and from there, by means of the bore 249, to the relief chamber 24. The valve member 71 of the second control valve 70 is also disposed with its sealing surface 224 spaced apart from the valve seat 222. The sleeve 250 rests against the actuator 72 due to the force of the third spring.

If the magnetic coil 216 is supplied with the increased first level of current, then the magnet armature 218 is moved, along with the valve member 71 and the rod 232. The first spring 176 is embodied as relatively rigid so that it is not compressed and, because it is supported on the valve member 163 by means of the disk 236 and the sleeve 234, it moves the valve member 163 of the first control valve 162 by compressing the second spring 177. As a result, the valve member 163 protrudes with its cylindrical section 244 into the bore 238 so that there is only a restricted passage and the conduit 248 is connected to the relief chamber 24 by means of a throttle restriction. The disk 236 protrudes radially beyond the sleeve 234 and comes into contact with the sleeve 250. If the magnetic coil 216 is then supplied with the second increased level of current, then the magnet armature 218 is attracted with an increased force so that the rod 232 and the valve member 163 are slid further counter to the force of the second spring 177. In addition, the sleeve 250 must also be moved counter to the force of the third spring 178 since the disk 236 rests against the sleeve 234. As a result, the sealing surface 242 of the valve member 163 comes into contact with the valve seat 240, thus closing the first control valve 162. If the magnetic coil 216 is then supplied with the third, highest level of current, then the magnet armature 218 is attracted with a further increased force so that the valve member 71 of the second control valve 70 is moved through compression of the first spring 176 and comes to rest with its sealing surface 224 against the valve seat 222. The end 233 of the rod 232 can move into the sleeve 234 without coming into contact with the valve member 163.

A spring plate 252 can be provided between the valve member 163 and the second spring 177 and its thickness can be used to vary the initial stress of the spring 177. A spring plate 254 can also be provided between the magnet armature 218 and the first spring 176 and its thickness can be used to vary the initial stress of the first spring 176. The valve member 71 of the second control valve 70 can be connected to a disk 256, which is disposed in the bore 214 and which defines the maximal stroke of the valve member 71 in the opening direction by coming into contact with the intermediary body 212. A disk 258 can be disposed between the rod 232 and the magnet armature 218 and its thickness can be used to adjust the residual air gap between the magnet armature 218 and the coil body 215. The residual air gap is the distance between the magnet armature 218 and the coil body 215 when the magnetic coil 216 is supplied with the highest, third level of current and both of the control valves 162 and 70 are closed.

The foregoing relates to preferred exemplary embodiments of the invention, it being understood that other variants and embodiments thereof are possible within the spirit and scope of the invention, the latter being defined by the appended claims.

I claim:

1. A fuel injection apparatus for an internal combustion engine, comprising a high-pressure fuel pump (10) and a fuel injection valve (12) connected to it for each cylinder of the engine,
the high-pressure fuel pump (10) having a pump piston (18), which is set into a stroke motion by the engine and which defines a pump working chamber (22), and is supplied with fuel from a fuel tank (24),
the fuel injection valve (12) having a pressure chamber (40) connected to the pump working chamber (22) and having an injection valve member (28) which controls at least one injection opening (32) and which the pressure prevailing in the pressure chamber(40) can move in an opening direction (29), counter to a closing force, in order to unblock the at least one injection opening (32),
a first control valve device (62; 162) that controls a connection (59) between the pump working chamber (22) and a relief chamber (24), and
a second control valve device (70) that controls a connection (68) between a control pressure chamber (52) of the fuel injection valve and a relief chamber (24), wherein the pressure prevailing in the control pressure chamber (52) at least indirectly acts on the injection valve member (28) in the closing direction and the control pressure chamber (52) is connected to the pump working chamber (22),
the first control valve device (62; 162) controlling an unthrottled connection (59) of the pump working chamber (22) to the relief chamber (24) and a connection (60) of the pump working chamber (22) to the relief chamber (24) by means of a throttle restriction (58) or by means of a pressure control valve (61).

2. The fuel injection apparatus according to claim 1, wherein the first control valve device (62; 162) and the second control valve device (70) are switched by means of a shared, electrically activated, electromagnetic actuator (72).

3. The fuel injection apparatus according to claim 1 wherein the first control valve device (62) comprises a first control valve (64) which controls the unthrottled connection (59) of the pump working chamber (22) to the relief chamber (24), and a second control valve (66), which controls the connection (60) of the pump working chamber (22) to the relief chamber (24) by means of the throttle restriction (58) or by means of the pressure control valve (61).

4. The fuel injection apparatus according to claim 2 wherein the first control valve device (62) comprises a first control valve (64) which controls the unthrottled connection (59) of the pump working chamber (22) to the relief chamber (24), and a second control valve (66), which controls the connection (60) of the pump working chamber (22) to the relief chamber (24) by means of the throttle restriction (58) or by means of the pressure control valve (61).

5. The fuel injection apparatus according to claim 3, wherein the two control valves (64, 66) of the first control valve device (62) are each embodied as a 2/2-port directional-control valve, which can be switched between an open switched position and a closed switched position.

6. The fuel injection apparatus according to claim 4, wherein the two control valves (64, 66) of the first control valve device (62) are each embodied as a 2/2-port directional-control valve, which can be switched between an open switched position and a closed switched position.

7. The fuel injection apparatus according to claim 1 wherein the first control valve device (162) comprises a single control valve (162) that is embodied as a 2/3-port directional-control valve which can be switched between a first open switched position in which the unthrottled connection (59) of the pump working chamber (22) to the relief chamber (24) is open, a second open switched position in which the connection of the pump working chamber (22) to the relief chamber (24) is only open by means of the throttle restriction (58), and a third closed switched position in which the pump working chamber (22) is disconnected from the relief chamber (24).

8. The fuel injection apparatus according to claim 2 wherein the first control valve device (162) comprises a single control valve (162) that is embodied as a 2/3-port directional-control valve which can be switched between a first open switched position in which the unthrottled connection (59) of the pump working chamber (22) to the relief chamber (24) is open, a second open switched position in which the connection of the pump working chamber (22) to the relief chamber (24) is only open by means of the throttle restriction (58), and a third closed switched position in which the pump working chamber (22) is disconnected from the relief chamber (24).

9. The fuel injection apparatus according to claim 2 wherein the actuator (72) is supplied with different levels of current in order to switch the valve devices (62; 162; 70).

10. The fuel injection apparatus according to claim 3 wherein the actuator (72) is supplied with different levels of current in order to switch the valve devices (62; 162; 70).

11. The fuel injection apparatus according to claim 4 wherein the actuator (72) is supplied with different levels of current in order to switch the valve devices (62; 162; 70).

12. The fuel injection apparatus according to claim 5 wherein the actuator (72) is supplied with different levels of current in order to switch the valve devices (62; 162; 70).

13. The fuel injection apparatus according to claim 6 wherein the actuator (72) is supplied with different levels of current in order to switch the valve devices (62; 162; 70).

14. The fuel injection apparatus according to claim 7 wherein the actuator (72) is supplied with different levels of current in order to switch the valve devices (62; 162; 70).

15. The fuel injection apparatus according to claim 2 when the actuator (72) is without current, the control valve devices (62; 162; 70) are each disposed in an open switched position that unblocks the connections (59; 61).

16. The fuel injection apparatus according to claim 3 when the actuator (72) is without current, the control valve devices (62; 162; 70) are each disposed in an open switched position that unblocks the connections (59; 61).

17. The fuel injection apparatus according to claim 4 when the actuator (72) is without current, the control valve devices (62; 162; 70) are each disposed in an open switched position that unblocks the connections (59; 61).

18. The fuel injection apparatus according to claim 5 when the actuator (72) is without current, the control valve devices (62; 162; 70) are each disposed in an open switched position that unblocks the connections (59; 61).

19. The fuel injection apparatus according to claim 6 when the actuator (72) is without current, the control valve devices (62; 162; 70) are each disposed in an open switched position that unblocks the connections (59; 61).

20. The fuel injection apparatus according to claim 7 when the actuator (72) is without current, the control valve devices (62; 162; 70) are each disposed in an open switched position that unblocks the connections (59; 61).

21. The fuel injection apparatus according to claim 9 when the actuator (72) is without current, the control valve devices (62; 162; 70) are each disposed in an open switched position that unblocks the connections (59; 61).
